(19) United States
(12) Patent Application Publication
(10) Pub. No.: US 2025/0004407 A1
(43) Pub. Date: Jan. 2, 2025

(54) IMAGE FORMING APPARATUS

(71) Applicant: CANON KABUSHIKI KAISHA, Tokyo (JP)

(72) Inventor: KOHEI DENO, Ibaraki (JP)

(21) Appl. No.: 18/744,945

(22) Filed: Jun. 17, 2024

(30) Foreign Application Priority Data
Jun. 27, 2023 (JP) 2023-105154

(51) Int. Cl. G03G 15/00

(52) U.S. Cl. CPC G03G 15/50; G03G 15/6505; G03G 15/6511; G03G 15/6514; G03G 15/6529

(57) ABSTRACT

An image forming apparatus includes a sheet supporting unit, a sheet feeding member, an image forming unit, a sheet conveyance unit, a detection unit, and a control unit. The control unit executes a first processing and a second processing. In the first processing, the control unit controls the image forming unit such that a position at which the image forming unit forms an image on a sheet of which the detection unit detects the position is adjusted. In the second processing, the control unit controls the image forming unit such that a position at which the image forming unit forms an image on a subsequent sheet is adjusted. When a state change operation that changes a feeding state at time of feeding the sheet occurs, the control unit executes the first processing. When the state change operation does not occur, the control unit executes the second processing.

### BACKGROUND OF THE INVENTION

### Field of the Invention

This disclosure relates to an image forming apparatus that forms an image on a sheet.

### Description of the Related Art

Hitherto, in image forming apparatuses that form an image on a sheet, sometimes, misalignment between the sheet and an image inscribed upon this sheet occurs. Especially, the following configuration is disclosed as an adjustment unit that adjusts the misalignment in a direction (sheet width direction) perpendicular to a sheet conveyance direction. For example, an image forming apparatus that includes a detection unit detecting a position of a side edge of the sheet in the sheet width direction in adjacent to a registration roller pair arranged upstream of a photosensitive drum in the sheet conveyance direction is known (refer to Japanese Patent Laid-Open No. 2009-151230).

In this image forming apparatus, a latent image is formed on the photosensitive drum using the sheet side edge position based on a detection amount by the detection unit as a reference, and, thus, an image writing position is aligned with a sheet position. In particular, in this image forming apparatus, the image writing position with respect to the photosensitive drum is adjusted based on the detection amount that the detection unit has detected with respect to the first sheet. Then, for the second and subsequent sheets, the image writing positions are adjusted based on the detection amounts that the detection unit has detected with respect to immediately preceding sheets. Further, in this image forming apparatus, when an image forming unit enters a standby state for an image quality adjustment during continuous sheet passing, with respect to the sheet that is waiting at the registration roller pair at that time, the image writing position with respect to the photosensitive drum is adjusted based on the detection amount that the detection unit has detected with respect to that sheet.

On the other hand, recently, types of sheets used for the image forming apparatuses are increased. Particularly, for the creation of high quality deliverables, the use of recording materials such as coated paper with excellent surface properties and high levels of smoothness is preferred. Due to a considerable adhesive force between sheets, the coated paper is susceptible to such as a sheet jam. Therefore, in a sheet feeding apparatus that feeds the sheet, a configuration thar blows airflow from a side edge of the sheet is developed (refer to Japanese Patent Laid-Open No. 2006-256819). According to this sheet feeding apparatus, it is possible to improve the reliability of a sheet feeding operation by preventing such as the sheet jam through the use of an air blow.

Incidentally, in the sheet feeding apparatus described in Japanese Patent Laid-Open No. 2006-256819, which includes a configuration that blows the airflow onto the side edge of the sheet, since the airflow is blown to the sheet placed on the sheet feed tray, the displacement of the side edge of the sheet in the sheet width direction is likely to occur. However, in a case of using the sheet feeding apparatus that blows the airflow onto the side edge of the sheet, there is a possibility that the following issues may arise in the image forming apparatus in which the image writing position of the latent image formed on the photosensitive drum is adjusted using the position of the side edge of the sheet as a reference based on the detection amount of the detection unit as described in Japanese Patent Laid-Open No. 2009-151230.

That is, the air blow may be performed for every predetermined number of sheets, for example, several to a dozen sheets. In such an instance, relatively large displacement of the sheet sometimes occurs immediately after the air blow has been performed. At this time, since, in the image forming apparatus described in Japanese Patent Laid-Open No. 2009-151230, the sheet position is detected continuously, a positional adjustment of the image writing position in the sheet that is conveyed immediately after the air blow is performed based on the detection amount with respect to the immediately preceding sheet. Therefore, with respect to the displacement of the sheet in the sheet width direction generated by air separation, there is a risk that it may not be possible to adjust the image writing position properly.

Further, for example, in image forming apparatuses which include a sheet cassette (sheet accommodating portion) storing the sheet, during a job that involves printing on a plurality of sheets, sometimes, the sheet depletes, and requires replenishment. In this case, there is a possibility that a side edge position of a sheet bundle in the sheet width direction after the replenishment may be greatly different from a side edge position of the sheet bundle in the sheet width direction immediately before the replenishment, and, in such a case, there is a risk that it may not be possible to adjust the image writing position properly.

Further, for example, in image forming apparatuses including a plurality of sheet cassettes that accommodate the sheet, sometimes, the sheet cassette is changed during the job of printing on the plurality of sheets. In this case, there is a possibility that a side edge position of the sheet bundle in the sheet width direction after the change may be greatly different from a side edge position of the sheet bundle in the sheet width direction before the change, and, in such a case, there is a risk that it may not be possible to adjust the image writing position properly.

The purpose of this disclosure is to provide an image forming apparatus that can improve accuracy for adjusting the image writing position with respect to the sheet, even when the side edge position of the sheet in the sheet width direction is changed during the print job.

### SUMMARY OF THE INVENTION

According to a first aspect of the present invention, an image forming apparatus includes a sheet supporting unit configured to support a sheet bundle, a sheet feeding member configured to feed an uppermost sheet of the sheet bundle supported on the sheet supporting unit by coming into contact with the uppermost sheet, an image forming unit configured to form an image on the sheet at an image formation position, a sheet conveyance unit configured to convey the sheet fed by the sheet feeding member to the image formation position, a detection unit configured to detect a position of the sheet in a sheet width direction intersecting with a sheet conveyance direction of the sheet conveyed by the sheet conveyance unit, and a control unit configured to control the sheet feeding member, the image forming unit, and the sheet conveyance unit. The control unit is configured to execute a first processing and a second processing. In the first processing, the control unit is configured to control the image forming unit based on a position of the sheet in the sheet width direction obtained by the detection unit such that a position at which the image forming unit forms an image on the sheet of which the detection unit detects the position in the sheet width direction is adjusted in the sheet width direction. In the second processing, the control unit is configured to control the image forming unit based on a position of a preceding sheet in the sheet width direction obtained by the detection unit such that a position at which the image forming unit forms an image on a subsequent sheet following the preceding sheet is adjusted in the sheet width direction. In a case where a state change operation that changes a feeding state at time of feeding the sheet occurs, the control unit is configured to execute the first processing. In a case where the state change operation does not occur, the control unit is configured to execute the second processing.

Further features of the present invention will become apparent from the following description of exemplary embodiments with reference to the attached drawings.

### BRIEF DESCRIPTION OF THE DRAWINGS

FIG. 1 is a cross-sectional view illustrating an image forming apparatus of the present embodiment.

FIG. 2 is a block diagram illustrating a control system of the image forming apparatus of the present embodiment.

FIG. 3 is a plan view illustrating a manual sheet feed portion of the present embodiment.

FIG. 4 is a side view illustrating the manual sheet feed portion of the present embodiment.

FIG. 5 is a schematic diagram illustrating a sheet conveyance unit of the present embodiment.

FIG. 6A is a flowchart illustrating a processing step of the positional adjustment control of the sheet in a sheet width direction in the sheet conveyance unit of the present embodiment, and illustrates the processing step of an operation of a feeding unit or a manual sheet feed tray.

FIG. 6B is a flowchart illustrating a processing step of the positional adjustment control of the sheet in the sheet width direction in the sheet conveyance unit of the present embodiment, and illustrates the processing step until the sheet is discharged via a registration roller pair.

FIG. 7 is a timing chart illustrating a sheet position and a control timing in the sheet conveyance unit of the present embodiment.

FIG. 8 is a graph illustrating a detection result by a contact image sensor (CIS) of the present embodiment.

FIG. 9A is a graph illustrating an image writing position using the CIS of a comparative example.

FIG. 9B is a graph illustrating a side edge position of the image using the CIS of the comparative example.

FIG. 10A is a graph illustrating an image writing position using the CIS of the present embodiment.

FIG. 10B is a graph illustrating a side edge position of the image using the CIS of the present embodiment.

### DESCRIPTION OF THE EMBODIMENTS

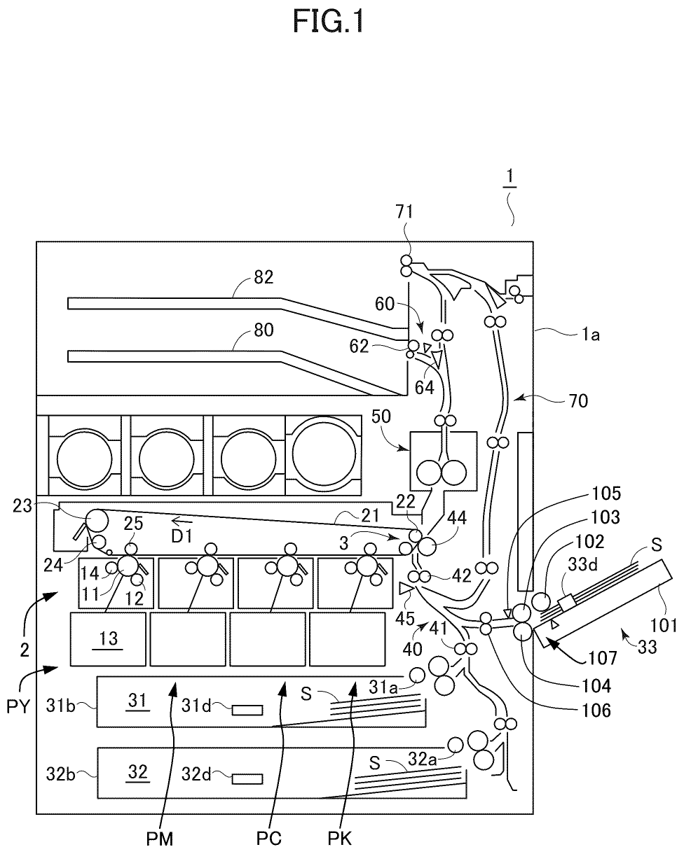

Hereinafter, using drawings, the present embodiment will be described. First, using FIG. 1, a schematic configuration of an image forming apparatus 1 of the present embodiment will be described. FIG. 1 is a schematic longitudinal cross-sectional view illustrating the image forming apparatus 1 of the present embodiment when viewed from the front side. The image forming apparatus 1 illustrated in FIG. 1 is the image forming apparatus 1 that uses, for example, an electrophotographic system. In recent years, an intermediate transfer tandem type method in which four colors of image forming stations PY, PM, PC, and PK of an image forming unit 2 are arranged in line on an intermediate transfer belt 21 so as to ensure adaptability to various types of sheets and improve printing productivity has become a leading method. Therefore, the image forming apparatus 1 of the present embodiment will be described as including the image forming unit 2 of the intermediate transfer tandem system. However, it is not limited to this, and it is possible to apply this disclosure also to monochrome or mono-color copiers and printers that include a single photosensitive drum. To be noted, unless otherwise explicitly stated, the dimensions, materials, and their relative positions and the like in the components of the image forming apparatus 1 are not to be construed as limiting the scope of this disclosure only to those aspects.

### Image Forming Apparatus

The image forming apparatus 1 includes a casing 1a, and is constituted by mainly including the image forming unit 2, a secondary transfer portion 3, and a sheet conveyance apparatus 100. The image forming unit 2 of the image forming apparatus 1 includes the image forming stations PY, PM, PC, and PK each respectively corresponding to the colors of yellow (Y), magenta (M), cyan (C), and black (Bk). The image forming unit 2 forms an image on a sheet S in the secondary transfer portion 3. Each of the image forming stations PY, PM, PC, and PK differs only in a color of toner, and is identical in a configuration. Therefore, the image forming station PY of yellow will be described as an example. The image forming station PY includes a photosensitive drum 11, serving as an image bearing member, a charge unit 12, an exposing unit 13, and a developing unit 14. The image forming unit 2 includes the intermediate transfer belt 21, a secondary transfer inner roller 22, and a primary transfer roller 25.

In the image forming unit 2, a surface of the photosensitive drum 11 has been uniformly charged beforehand by the charge unit 12, and, by driving the exposing unit 13 based on a signal of image information, an electrostatic latent image is formed on the surface of the photosensitive drum 11 that rotates. The electrostatic latent image formed on the surface of the photosensitive drum 11 is visualized as a toner image through development with the toner by the developing unit 14. Thereafter, a predetermined pressurizing force and an electrostatic bias are applied by the primary transfer roller 25, and the toner image is primarily transferred onto the intermediate transfer belt 21.

The intermediate transfer belt 21 is stretched by rollers such as a drive roller 23, a tension roller 24, and the secondary transfer inner roller 22, and is driven and conveyed in an arrow direction D1 illustrated in FIG. 1. An image forming process performed in parallel for each color of Y, M, C, and Bk is executed at a timing when the toner image is superimposed on the toner image of the upstream color that has been primarily transferred onto the intermediate transfer belt 21. As a result, finally, the toner image of a full color is formed on the intermediate transfer belt 21, and this toner image is conveyed to the secondary transfer portion 3. The secondary transfer portion 3 is an example of an image formation position, and includes a transfer nip portion formed by the secondary transfer inner roller 22 and a secondary transfer outer roller 44, which are positioned to face each other, and, by applying a predetermined pressurizing force and an electrostatic bias, the toner image is secondarily transferred onto the sheet S.

On the other hand, feeding units 31 and 32 are disposed in a lower part of the image forming apparatus 1. The feeding unit 31 is an example of a first sheet supporting unit and a sheet supporting unit, supporting a sheet bundle, and the feeding unit 32 is an example of a second sheet supporting unit and a sheet supporting unit, supporting the sheet bundle. The sheet S is accommodated in each of sheet cassettes 31b and 32b, and a sheet size is detected by each of size detection sensors 31d and 32d. In each of the sheet cassettes 31b and 32b, an uppermost sheet S of the sheet bundle is fed by a sheet feeding member 31a or 32a, passes through a pre-registration roller pair 41, and is conveyed to a registration roller pair 42. The sheet feeding members 31a and 32a are examples of a sheet feeding member, and are pickup rollers that each feed the uppermost sheet S by coming into contact with the uppermost sheet S of the sheet bundle supported on the feeding unit 31 or 32. The sheet cassette 31b is an example of a first sheet accommodating portion and a sheet accommodating portion that accommodates the sheet S, and is detachable with respect to the casing 1a. The sheet cassette 32b is an example of a second sheet accommodating portion and the sheet accommodating portion that stores the sheet S, and is detachable with respect to the casing 1a. To be noted, in the present specification, the pre-registration roller pair 41 and the registration roller pair 42 are respectively abbreviations of a pre-registration roller pair and a registration roller pair.

The pre-registration roller pair 41 corrects the skew of the sheet S. In particular, the pre-registration roller pair 41 brings a leading edge of the sheer S to abut against a nip portion of the registration roller pair 42 that is stopping. Thereby, the pre-registration roller pair 41 loops the sheet S, and performs the skew correction. The registration roller pair 42 conveys the sheet S to the secondary transfer portion 3 in synchronization with a timing at which the toner image on the intermediate transfer belt 21 is transferred onto the sheet S.

After the transfer, the sheet S is conveyed to a fixing unit 50, and the toner image is melted and bonded onto the sheet by applying heat and pressure. After the fixing, the sheet S is conveyed to a sheet discharge portion 60, and a conveyance path is switched by a switching portion 64 depending on whether a conveyance mode is simplex or duplex. In a case of the simplex mode, the sheet S is loaded onto a sheet discharge tray 80 by a sheet discharge roller 62. On the other hand, in the case of the duplex mode, a reverse roller 71 temporarily stops in a state in which a predetermined distance is remained for a trailing edge of the sheet S to pass through the reverse roller 71, and then the reverse roller 71 is reversed. Thereby, the sheet is conveyed again to the registration roller pair 42 via a duplex conveyance portion 70, and the image formation on a second surface of the sheet S in the image forming unit 2 and the fixing are performed. After the fixing, the sheet S is loaded on the sheet discharge tray 80 or a sheet discharge tray 82 via the switching portion 64 by the sheet discharge roller 62 or the reverse roller 71.

To be noted, the image forming apparatus 1 of the present embodiment will be described as adopting, for example, a center-referenced sheet conveyance method. That is, the sheet S is conveyed by aligning a center of the sheet in the sheet width direction with a center of the sheet conveyance path in a direction perpendicular to the sheet conveyance direction.

### Control System

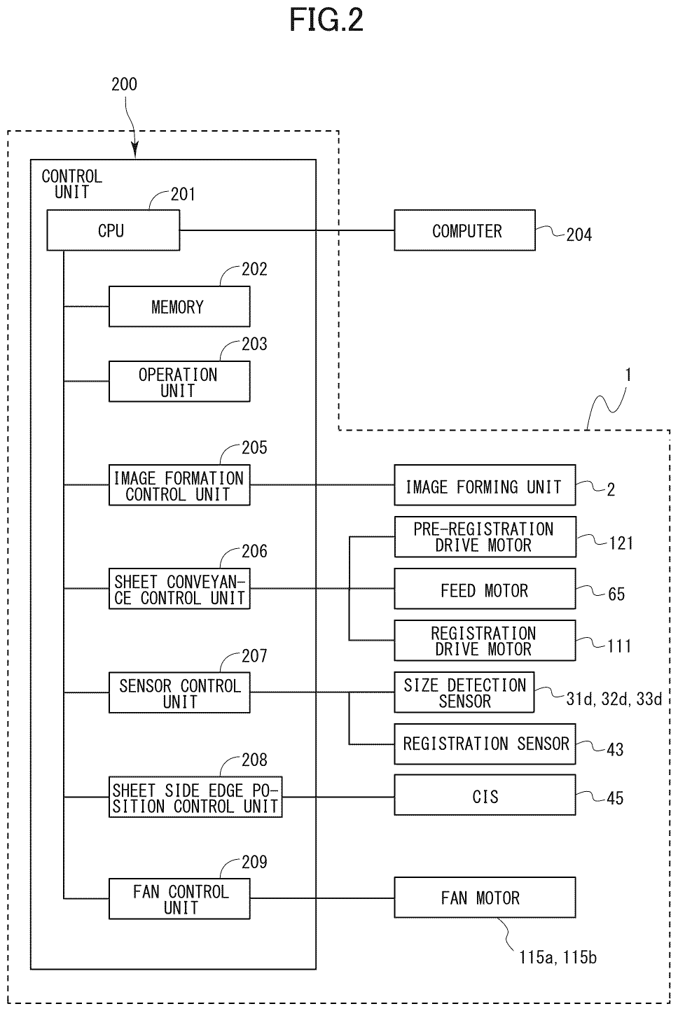

FIG. 2 is a block diagram illustrating a control unit of the image forming apparatus 1. The control unit 200 includes such as a central processing unit (CPU) 201 and a memory 202. The CPU 201 executes various processing performed by the image forming apparatus 1 by running such as predetermined control programs. The memory 202 includes such as, for example, a random access memory (RAM) and a read only memory (ROM), and stores various programs and data in a predetermined storage area.

Further, the control unit 200 includes various function units such as an operation unit 203, an image formation control unit 205, a sheet conveyance control unit 206, a sensor control unit 207, a sheet side edge position control unit 208, and a fan control unit 209. The operation unit 203 accepts various operations performed by a user, including the input of various information (such as information on size, grammage, and surface characteristics) about the sheet which the user uses for the printing, as well as such as instructions for starting and stopping the printing. The image formation control unit 205 issues instructions to the image forming unit 2 including the exposing unit 13, and controls the image formation.

The sheet conveyance control unit 206 issues instructions to a feed motor 65, a pre-registration drive motor (pre-registration drive motor) 121, and a registration drive roller (registration drive motor) 111, described below, and controls the conveyance of the sheet S. The sensor control unit 207 controls a start or stop of the detection of such as the size detection sensors 31d, 32d, and 33d and a registration sensor 43, and receives a detection result from each of these sensors. The sheet side edge position control unit 208 receives a detection signal value of a contact image sensor (CIS) 45, and converts the signal value to a sheet side edge position. To be noted, for example, it is possible to configure such that the CPU 201 can receive various information relating to the sheet used for the printing via a computer 204 connected via a network.

### Manual Sheet Feed Portion

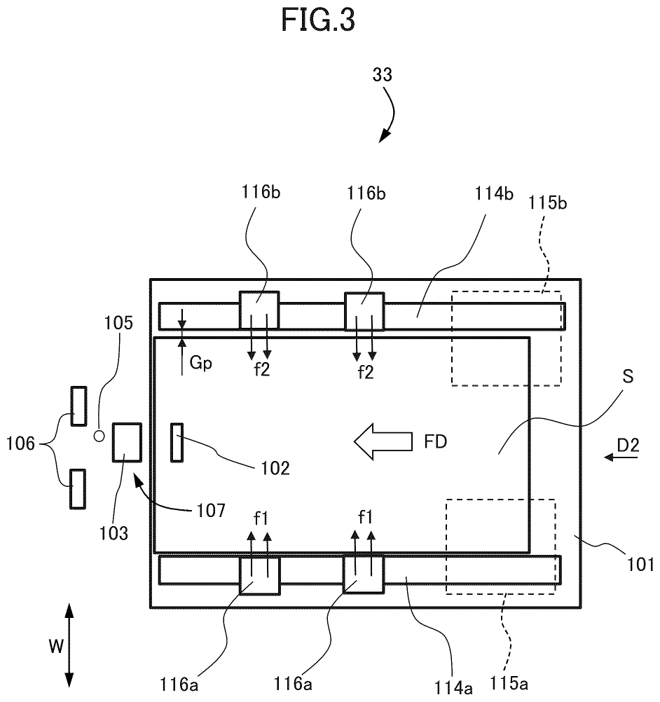

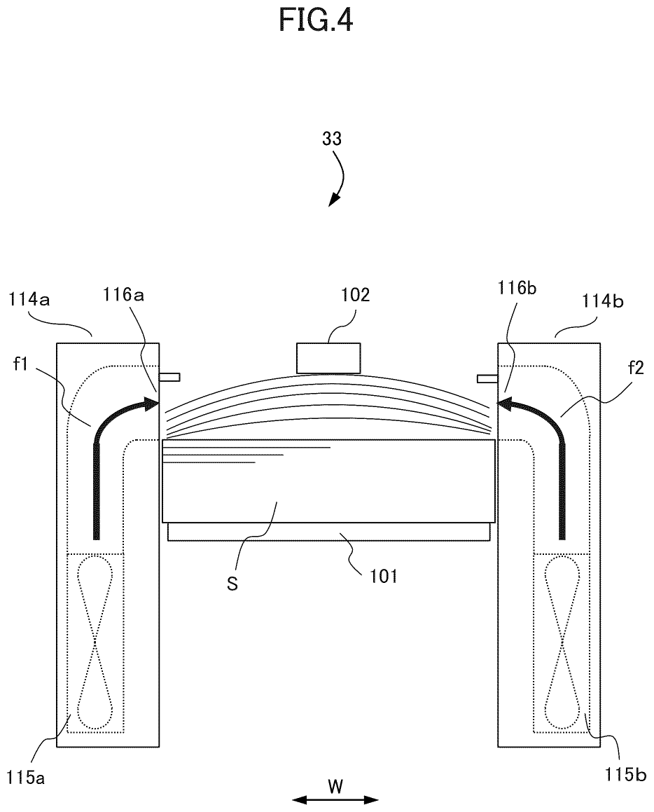

Next, using FIGS. 3 and 4, a manual sheet feed portion 33 will be described. FIG. 3 is a plan view illustrating the manual sheet feed portion 33, and FIG. 4 is a side view of the manual sheet feed portion 33 when viewed in an arrow direction D2 illustrated in FIG. 3. The manual sheet feed portion 33 is an example of the sheet supporting unit that supports the sheet bundle. The manual sheet feed portion 33 includes a manual sheet feed tray 101, a pickup roller 102, and a separation portion 107 that separates the sheet S fed from the pickup roller 102. The pickup roller 102 is an example of a sheet feeding member, and feeds the uppermost sheet S by coming into contact with the uppermost sheet S of the sheet bundle supported on the manual sheet feed portion 33. The separation portion 107 includes a feed roller 103 and a retard roller 104 (refer to FIG. 1).

The manual sheet feed tray 101 is an example of a manual feed tray that supports a manually fed sheet. The size detection sensor 33d (refer to FIG. 1) is disposed on the manual sheet feed tray 101, and the sheet size of the sheet S placed on the manual sheet feed tray 101 is detected. On the manual sheet feed tray 101, side edge regulation plates 114a and 114b for regulating positions of the sheet S in a direction (sheet width direction W) intersecting (for example, perpendicularly intersecting) with the sheet conveyance direction FD are disposed on both sides in the sheet width direction W. A fan motor 115a and an air blow nozzle 116a are mounted to the side edge regulation plate 114a. By driving the fan motor 115a, airflow f1 is blown out from the air blow nozzle 116a, and is directed onto a side surface of the sheet bundle placed on the manual sheet feed tray 101. By blowing the airflow f1 from the fan motor 115a onto a side edge portion of the sheet S as separation airflow, an upper portion of the sheet bundle is levitated, and thereby an adhesive force between the sheets is reduced. That is, the fan motor 115a is an example of a fan that blows the airflow, and the air blow nozzle 116a is an example of an air separation unit that separates the sheets by blowing the airflow onto the side surface of the sheet bundle supported on the manual sheet fed portion 33.

Similarly, a fan motor 115b and an air blow nozzle 116b are mounted to the side edge regulation plate 114b. By driving the fan motor 115b, airflow f2 is blown out from the air blow nozzle 116b, and is directed onto a side surface of the sheet bundle placed on the manual sheet feed portion 101. The side surface to which the airflow f2 is directed is on an opposite side of the side edge regulation plate 114a. By blowing the airflow f2 from the fan motor 115b onto the side edge portion of the sheet S as the separation airflow, in conjunction with the airflow f1 being blown from the opposite side, the upper portion of the sheet bundle is effectively levitated, and thereby the adhesive force between the sheets is reduced. That is, the fan motor 115b is an example of the fan that blows the airflow, and the air blow nozzle 116b is an example of the air separation portion that separates the sheets by blowing the airflow onto the side surface of the sheet bundle supported on the manual sheet feed portion 33.

When the manual sheet feed portion 33 is selected by the user and an operation to begin the image formation is executed, sheet feeding is started from the manual sheet feed portion 33. In a case where the sheet S placed on the manual sheet feed tray 101 is, for example, coated paper, the fan motors 115a and 115b of the side edge regulation plates 114a and 114b operate. Thereby, the airflows f1 and f2 are blown onto the edges of the sheet bundle in the sheet width direction W from the air blow nozzles 116a and 116b.

After a predetermined period of time subsequent to starting to blow the airflows f1 and f2, the sheet S at the uppermost position, whose adhesive force between the sheets has been reduced, is fed by the pickup roller 102, and is sent to the separation portion 107 constituted by the feed roller 103 and the retard roller 104. The sheet S is separated into one sheet at a time in the separation portion 107, and a sheet detection sensor 105 detects the leading edge of the sheet S. Further, the sheet S is conveyed to the registration roller pair 42 by a conveyance roller pair 106.

Here, the side edge regulation plates 114a and 114b serve to suppress the skew of the sheet S that occurs during the feeding of the sheet S and in various conveyance rollers located downstream of the pickup roller 102 in the sheet conveyance direction, and the displacement of the sheet in the sheet width direction W. However, in practice, as illustrated in FIGS. 3 and 4, sometimes, a small gap Gp occurs between the side edge regulation plates 114a and 114b and the side edge of the sheet S. There is a possibility that, due to the occurrence of the gap Gp, the respective sheet S may be skewed or displaced in the sheet width direction W during the feeding and conveyance of the sheet S.

Further, as illustrated in FIG. 4, since the levitated sheet S may, for example, curve upward at a central portion in the sheet width direction W, there is a possibility that the gap Gp with the side edge regulation plates 114a and 114b may be further widened. In such a case, there is a risk that the skew and the displacement in the sheet width direction W may further worsen. Hitherto, in conventional image forming apparatuses, since the sheet S may be conveyed to the secondary transfer portion 3 under conditions of the skewing or the displacement in the sheet width direction W, there is a risk of misalignment in the image formed on the sheet S. Therefore, in the present embodiment, the side edge position of the sheet S in the sheet width direction W is detected.

### Configuration for Detection of Sheet Side Edge Portion

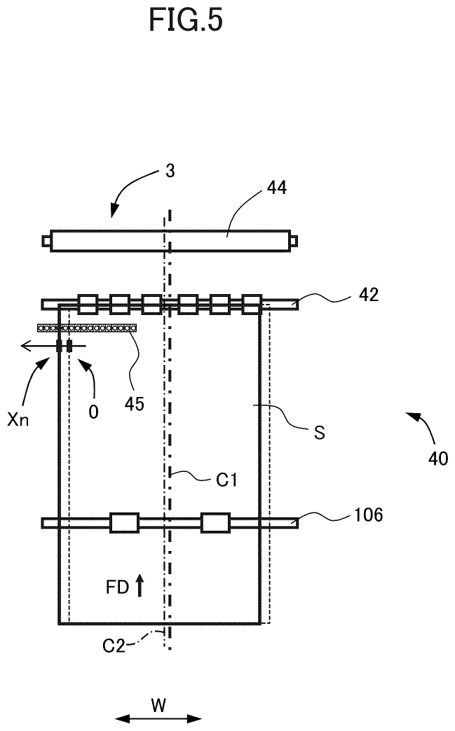

Next, a configuration of the present embodiment for the detection of the side edge position (edge position) of the sheet S in the sheet width direction W will be described. FIG. 5 is a schematic diagram illustrating a configuration from the conveyance roller pair 106 to the secondary transfer portion 3. In the present embodiment, the image forming apparatus 1 includes a sheet conveyance unit 40 configured to convey the sheet S from the feeding units 31 and 32 and the manual sheet feed portion 33 to the secondary transfer portion 3. The sheet conveyance unit 40 conveys the sheet S, which is fed by the sheet feed unit 31a or 32a or the pickup roller 102, to the secondary transfer portion 3. Here, a configuration in which the sheet conveyance unit 40 conveys the sheet S fed from the manual sheet feed portion 33 to the secondary transfer portion 3 will be described.

A contact image sensor (CIS) 45 for detecting the side edge position of the sheet S is disposed adjacently upstream of the registration roller pair 42 in the sheet conveyance direction FD. The CIS 45 is an example of a detection unit, and detects a position of the sheet S, which is conveyed by the sheet conveyance unit 40, in the sheet width direction W intersecting with the sheet conveyance direction. The CIS 45 is arranged at a position closer to one side (left side in FIG. 5) with respect to a center line C1 in the sheet width direction W of the sheet S which is nipped and conveyed by both the conveyance roller pair 106 and the registration roller pair 42. This is because, in a positional adjustment of the sheet S, it is sufficient to detect only one side of the side edge positions of the sheet S. Based on a detection result of the CIS 45, the control unit 200 calculates a displacement amount between a design target position and the detection result.

The purpose of the present embodiment is to suppress the misalignment of the image transferred onto the sheet S even in a case where the sheet S is displaced in the sheet width direction W in the manual sheet feed portion 33 in which the air blow is performed. Further detailed description will be provided below.

### Processing Step for Positional Adjustment Control

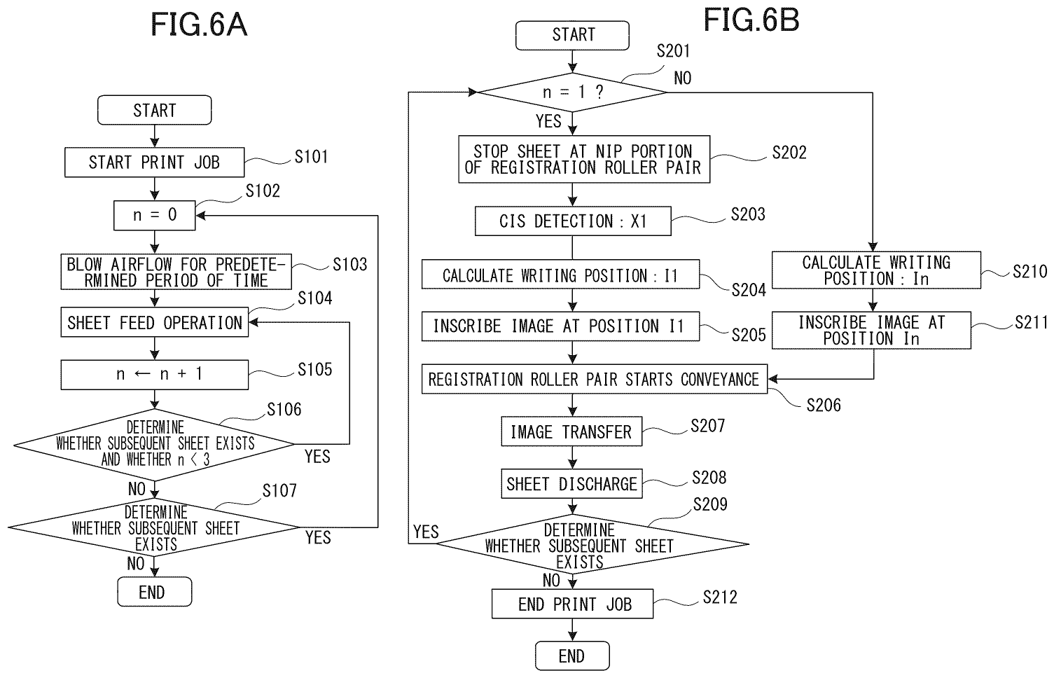

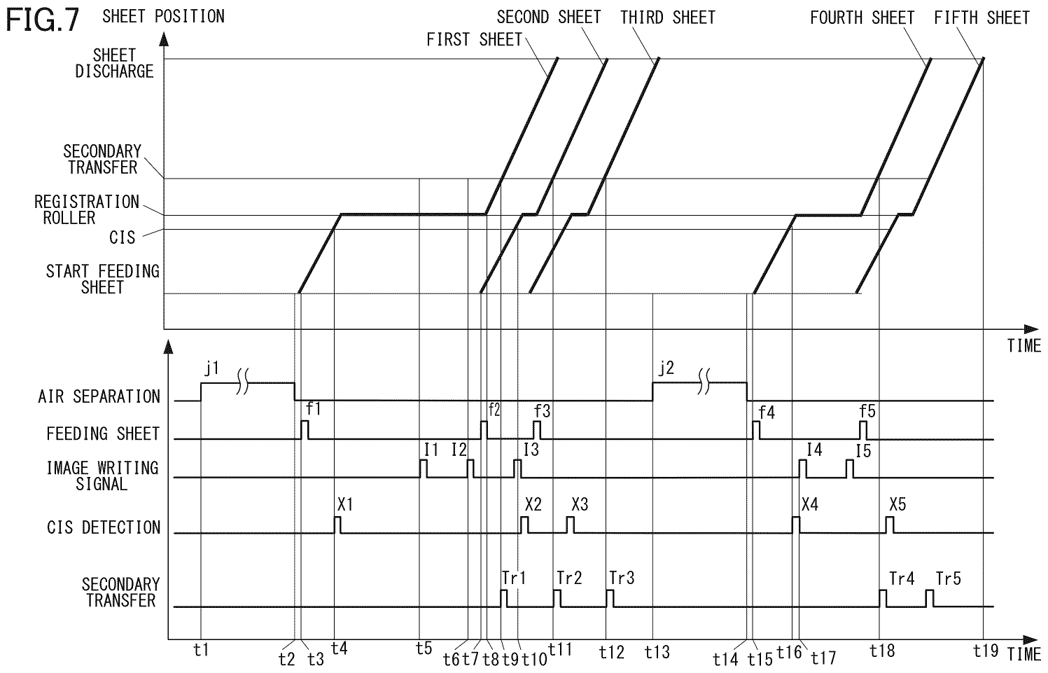

FIG. 6A is a flowchart illustrating a processing step for the positional adjustment control of the sheet S in the sheet width direction W in the feeding units 31 and 32 or the manual sheet feed portion 33 of the image forming apparatus 1. FIG. 6B is a flowchart illustrating a processing step in which the sheet S fed into the image forming apparatus 1 passes through the registration roller pair 42, and is discharged after the image formation. FIG. 7 illustrates, in the upper section, a plot representing a position of a leading edge of a single sheet with respect to time during continuous sheet passing, and, in the lower section, a timing chart depicting various control timings corresponding to the plots illustrated in the upper section. Here, to facilitate understanding, the processing steps for the positional adjustment control of the sheet S placed on the manual sheet feed portion 33 will be described, and an example of continuous five-sheet passing is illustrated. Further, in the present embodiment, a state change operation that changes feeding conditions during feeding the sheet S is an operation of separating the sheet S using the air blow nozzles 116a and 116b.

The control unit 200 starts a print job (STEP S101), and sets a counter value n=0 (STEP S102). The control unit 200 starts the air blow in the manual sheet feed portion 33 (STEP S103, at time t1 in FIG. 7). The control unit 200 sets a period of time for the air blow to, for example, t2−t1=10 seconds (sec), and, thereby, it is possible to reduce the adhesive force between the sheets by levitating the sheet S.

Thereafter, stopping the drive of the fan motors 115a and 115b (at time t2 in FIG. 7) causes the sheet S, which has been in a levitated state, to attempt to return to a state of the sheet bundle before the levitation, as the air escapes from between the sheets. At this time, the adhesive force between the sheets remains reduced, and, as curvature of the sheet S is diminished to be brought into a flatter profile, the gap Gp between the side edge regulation plates 114a and 114b and the sheet S is reduced. Then, the control unit 200 starts a feeding operation (STEP S104, at time t3 in FIG. 7). As described above, by performing the air blow before the feeding operation of the sheet S and by stopping the airflow at the time of feeding the sheet S, it becomes possible to achieve both the reduction of the adhesive force of the sheet S and the stabilization of the side edge position of the sheet S. That is, the control unit 200 blows the airflow by the air blow nozzles 116a and 116b before the pickup roller 102 starts feeding the sheet S, and, after stopping the air blow by the air blow nozzles 116a and 116b, starts feeding the sheet S by the pickup roller 102.

The control unit 200 increments the counter value n by one (STEP S105), and determines whether or not a subsequent sheet exists and whether or not n<3 (STEP S106). In a case where the control unit 200 determines that the subsequent sheet exists and n<3 (STEP S106: YES), the control unit 200 executes the feeding operation of the next sheet S (STEP S104). In a case where the control unit 200 determines that the subsequent sheet does not exist or does not satisfy n<3 (STEP S106: NO), the control unit 200 determines whether or not the subsequent sheet exists (STEP S107).

In a case where the control unit 200 determines that the subsequent sheet exists (STEP S107: YES), again the control unit 200 sets the counter value n=0 (STEP S102), and continues the feeding of the sheet S. That is, the counter value n is utilized to define the number N of sheets that are continuously passed without activating the air blow. Here, for example, when n and N have both become 3, in a case where the subsequent sheet still exists, the control unit 200 returns to S102, and resets the counter value n to 0. Thereafter, at time t13 in FIG. 7, the control unit 200 repeats the air blow for the predetermined period of the time (in this case, t14−t13=10 sec) and the feeding operation. That is, the control unit 200 separates the sheet S by the air blow nozzles 116a and 116b every time when the pickup roller 102 has fed a predetermined number of sheets (in this case, 3 sheets).

In a case where the control unit 200 determines that the subsequent sheet does not exist (STEP S107: NO), the control unit 200 ends the processing. Therefore, in the example described above, in the continuous five-sheet passing job, the control unit 200 performs the air blow for 10 sec before feeding the sheet S, passes three sheets while halting the airflow, reactivates the air blow for 10 sec after having passed three sheets, passes two sheets while halting the airflow, and ends the feeding operation.

Next, using FIG. 6B, control subsequent to feeding the sheet will be described. The sheet S that has been fed is conveyed to the registration roller pair 42. The control unit 200 determines whether or not the counter value n=1 (STEP S201). In a case where the control unit 200 determines that the counter value n=1 (STEP S201: YES), the sheet S that is the first sheet after the air blow operation is conveyed to the CIS 45, and is stopped at the nip portion of the registration roller pair 42 (STEP S202). The control unit 200 detects the sheet side edge position by the CIS 45 (STEP S203). The control unit 200 performs a first processing, described below, with respect to a single sheet of the sheet S.

Here, the sheet side edge position of the first sheet is detected as X1 (at time t4 in FIG.7), and a sheet side edge position of the fourth sheet is detected as X4 (at time t16 in FIG. 7). After time t4 in FIG. 7, the control unit 200 calculates an image writing position I1 base on X1 for the first sheet (STEP S204), and inscribes the image at the image writing position I1 by forming an image writing signal (STEP S205, at time t5 in FIG. 7). To be noted, the image writing position is a position in the sheet width direction at which the image is formed on the sheet. At this time, the control unit 200 executes the first processing. The first processing refers to processing in which the position in the sheet width direction at which the image is formed in the secondary transfer portion 3 is adjusted by controlling the image forming unit 2 based on the position in the sheet width direction of the sheet S detected by the CIS 45. Thereafter, the control unit 200 starts the conveyance by the registration roller pair 42 (STEP S206), executes secondary transfer (STEP S207, at time t9 in FIG. 7), and performs a sheet discharge operation (STEP S208). As described above, in a case where the state change operation (air separation) to change a feeding state at the time of feeding the sheet S occurs, the control unit 200 can execute the first processing with respect to the sheet S that is fed.

In this control, the sheet S is held in a standby state at the registration roller pair 42 for the duration of time corresponding to t8−t4 in FIG. 7, and the productivity of image output decreases. However, generally, in image forming apparatuses, at the time of printing the first sheet, sometimes, control units require time to develop the image data as the print job and time for pre-processing the image formation in image forming units. In the present embodiment, these required time periods and the standby time at the registration roller pair 42 are overlapped. Thereby, as described above, while keeping the decline in the productivity to a minimum, by determining the image writing position I1 for the first sheet based on the CIS detection result X1 of the first sheet, it becomes possible to adjust the image writing position I1 with high precision.

The control unit 200 determines whether or not the subsequent sheet exists (STEP S209). In a case where the control unit 200 determines that the subsequent sheet exists (STEP S209: YES), again the control unit 200 determines whether or not the counter value n=1 (STEP S201). Here, in a case where the control unit 200 determines that the counter value n does not satisfy n=1 (STEP S201: NO), the control unit 200 calculates an image writing position In based on Xn (STEP S210), and inscribes the image at the image writing position In by forming the image writing signal (STEP S211). In the present embodiment, a case where the control unit 200 determines that the counter value n does not satisfy n=1 is a case where n is either 2 or 3. In such a case, the control unit 200 executes a second processing. The second processing is processing in which, based on a position in the sheet width direction W of the preceding sheet which has been detected by the CIS 45, by controlling the image forming unit 2, a position in the sheet width direction W, at which the image is formed in the secondary transfer portion 3, of the sheet S subsequent to the preceding sheet is adjusted. Subsequent conveyance and transfer operations are the same as with the first sheet (STEPS S206 to S209). In the case where the control unit 200 determines that the subsequent sheet does not exist (STEP S209: NO), the control unit 200 ends the print job (STEP S212). As describe above, in the absence of the stage change operation (air separation), the control unit 200 can execute the second processing with respect the sheet S that is fed.

As illustrated in FIG. 7, the formation of the image writing signal with respect to an image writing position I2 for the second sheet is performed at time t6, and the time to is prior to the detection of the respective sheet S by the CIS 45, which is at time t10. That is, in the second processing, the control unit 200 forms the image writing signal of the sheet prior to detecting the position in the sheet width direction of the respective sheet. Therefore, it is not possible to determine the image writing position based on the CIS detection result X2 of the respective sheet S. This is the same as with the third sheet, and, in this case, the image writing position In is determined based on the CIS detection results of the preceding sheets. For example, the image writing position I2 is determined based on the CIS detection result X1, and the image writing position I3 is determined based on an average value of the CIS detection results X1 and X2. That is, in the present embodiment, with respect to the second sheet subsequent to the state change operation, the control unit 200 executes the second processing by setting the image writing position I2 to be the same as the image writing position I1 of the first sheet. Further, with respect to the third sheet subsequent to the state change operation, the control unit 200 executes the second processing by setting the image writing position I3 to be an average value of the image writing positions I1 and I2 of a plurality of preceding sheets.

As described above, the air blow operation is performed after feeding three sheets of the sheet S, and, thereafter, the fourth sheet is fed (at time t15). The fourth sheet reaches the CIS 45, and a CIS detection result X4 is obtained (at time t16). The control unit 200 executes the first processing with respect to the fourth sheet, and the image writing signal for the fourth sheet is determined based on the CIS detection result X4 of the respective sheet S. Here, a sheet passing interval t18−t12 from the third sheet to the fourth sheet is longer than a sheet passing interval t11−t9 from the first sheet to the second sheet. This corresponds to a total of the duration of the air blow (in this case, 10 sec) and the time taken to inscribe the image after the sheet S has reached the CIS 45. With respect to the sheet passing of the fifth sheet, the operation becomes the same as with the second sheet, and the control unit 200 executes the second processing.

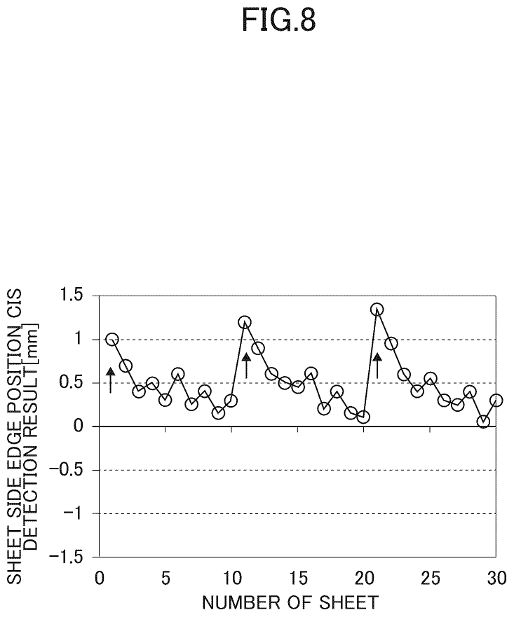

As an example, FIG. 8 is a graph illustrating a CIS detection result X in continuous 30-sheet passing, where N=10 sheets. Here, the air blow operations are performed in the manual sheet feed portion 33 before feeding the first, eleventh, and twenty first sheets. Therefore, at the first, eleventh, and twenty first sheets, the detection results of the CIS 45 greatly deviate with respect to the detection results immediately before, and, thereafter, are each gradually stabilized.

### Comparative Example

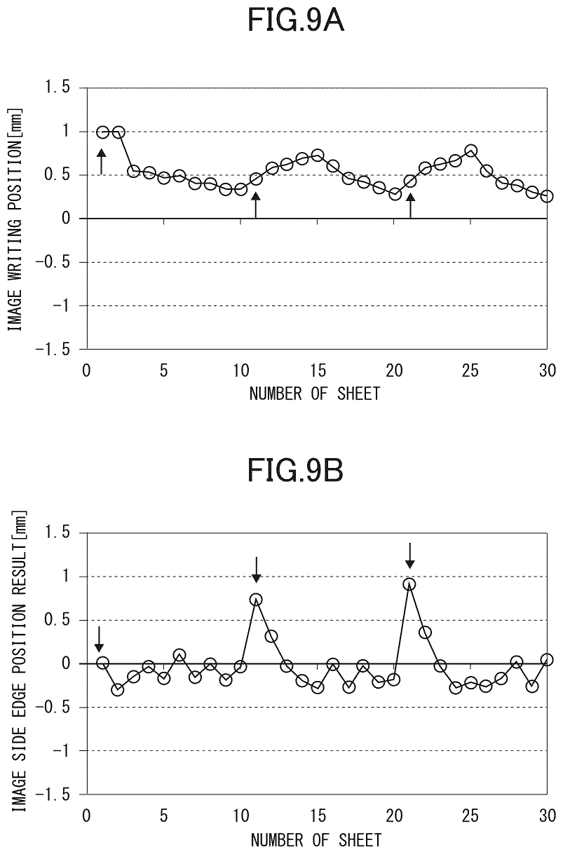

In image forming apparatuses in which the CIS is not mounted upstream of the registration roller pair in the sheet conveyance direction, the displacement of the sheet side edge position at the registration roller pair almost directly becomes the misalignment of the image writing position. For comparison, an image forming apparatus which includes the CIS upstream of the registration roller pair in the sheet conveyance direction, and determines the image writing position of the respective sheet based on the CIS detection result of the preceding sheet is mentioned as a comparative example. A result of the image writing position in a case where the image forming apparatus of the comparative example as described above is used are illustrated in FIGS. 9A and 9B. In FIG. 9A, the image writing position is calculated based on the average of the sheet side edge positions of the preceding five sheets. In a case where an image writing control of FIG. 9A is executed when values illustrated in FIG. 8 are obtained as the CIS detection results, a result of an image side edge position is illustrated in FIG. 9B. In the comparative example, for sheets with small differences in positions in the sheet width direction compared to the preceding sheets in the continuous sheet passing, the image registration is satisfactory. However, for the eleventh and twenty first sheets, the inability to accurately predict and control the image writing position results in a significant misalignment of the image registration. To be noted, with respect to the first sheet, since it is possible to adjust the image writing position based on the CIS detection result of the respective sheet, there is a minimal misalignment.

### Example of Present Embodiment

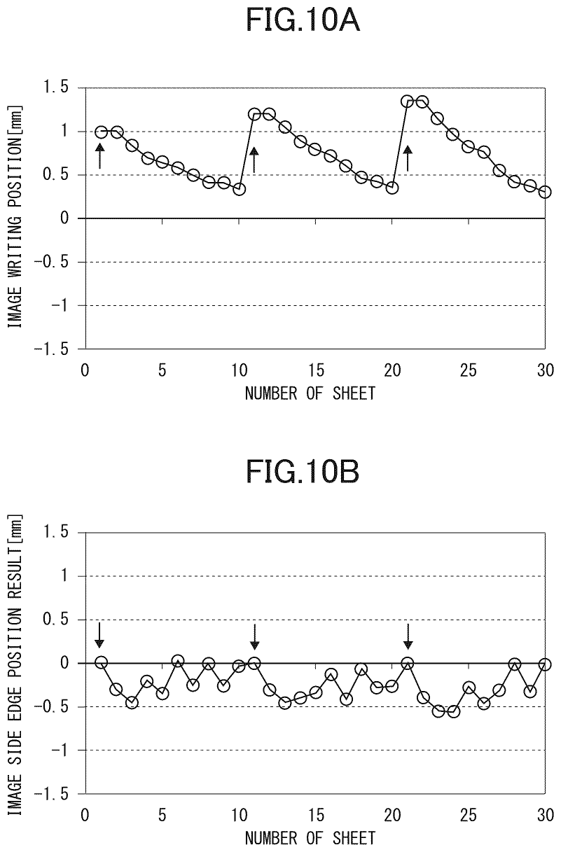

A result of the control of an example to which the present embodiment is applied is illustrated in FIGS. 10A and 10B. Also, in this example, the sheet position is greatly displaced by the air blow as illustrated in FIG. 8. Therefore, as illustrated in FIG. 10A, with respect to the first sheets after the air blow, that is, the first, eleventh, and twenty first sheets, the images are inscribed at positions which are adjusted based on the CIS detection results of the respective sheets. Thereby, as illustrated in FIG. 10B, the misalignments of the image writing positions in the first, eleventh, and twenty first sheets are improved to almost zero. Further, with respect to the subsequent sheets following the first, eleventh, and twenty first sheets, since the images are inscribed based on the detection results of the previously preceding sheets, it is possible to improve the alignment of the image writing position as with the comparative example illustrated in FIGS. 9A and 9B. That is, in the present embodiment, the control unit 200 executes the second processing on the second sheet subsequent to the stage change operation by setting the image writing position to be the same as the image writing position of the first sheet. Further, when the subsequent sheet is a third one onward after the state change operation, until the next state change operation occurs, the control unit 200 executes the second processing by setting the image writing positions based on the averages of the image writing positions of previously preceding five sheets.

As described above, according to the image forming apparatus 1 of the present embodiment, in the case where the air separation that is the state change operation has occurred, the control unit 200 executes the first processing with respect to the sheet S that is fed, and in the case where the air separation that is the state change process has not occurred, the control unit 200 executes the second processing with respect to the sheet S that is fed. Therefore, since, with respect to the sheet that is fed immediately after the air separation has been performed, the image writing position is adjusted based on a detection amount of the respective sheet, it becomes possible to adjust the image writing position properly. Further, since, with respect to the subsequent sheets, the image writing position is adjusted based on the detection amounts of the previously preceding sheets, it is possible to suppress a decrease in the productivity. Therefore, even if the sheet side edge position in the sheet width direction is changed during the print job, it is possible to improve the accuracy for adjusting the image writing position with respect to the respective sheet without decreasing the productivity.

As described above, in the present embodiment, sheet feeding performance is improved by the air blow, and the image writing position of the first sheet subsequent to the air blow operation is determined based on the CIS detection result of the respective sheet. Thereby, since it is possible to cancel the displacement of the sheet side edge position caused by the air blow, it is possible to improve the accuracy of the image registration. Further, by synchronizing this control with a timing of the air blow, it is possible to suppress the decrease in the productivity. According to the present embodiment, in sheet feed apparatuses that include an air blow mechanism, by detecting the sheet side edge position and by properly executing the image writing position control based on the detection result, it is possible to simultaneously achieve expansion of applicable types of media, miniaturization of apparatus size, and the accuracy of the image registration.

Further, according to the image forming apparatus 1 of the present embodiment, the air separation is adopted as the state change operation. Therefore, in the air separation in which the side edge position of the sheet S is especially susceptible to displace, it is possible to accurately adjust the side edge position of the image.

According to this disclosure, even if the side edge position of the sheet in the sheet width direction is changed during the print job, it is possible to improve the accuracy for adjusting the image writing position with respect to the sheet.

### Other Embodiments

To be noted, while, in the embodiment described above, specific numerical values are used for illustration purposes, however, it is not limited to this. For example, while the duration of time for the air blow is set to 10 sec, the adhesion between the sheets depends on such as a media type and surrounding environmental conditions, and the duration of the time for the air blow may be determined according to each specific condition. Further, the number of sheets continuously passed without activating the air blow, N, is set to 3 sheets in FIGS. 6A, 6B, and 7, and to 10 sheets in FIGS. 8 and 9A to 10B. However, it is not limited to this, and the number can be determined based on a balance between feeding performance and the accuracy of sheet side edge positioning.

Further, in the embodiment described above, in the second processing, the control unit 200 sets the image writing position for the second sheet after the state change operation to be the same as the image writing position of the first sheet, and, for the third and subsequent sheets, until the next state change operation occurs, the image writing positions are determined based on the average of the image writing positions of a plurality of previously preceding sheets. However, it is not limited to this. For example, in the second processing, the control unit 200 may set the image writing positions for the second and subsequent sheets after the state change operation to be also the same as the image writing position of the first sheet. Alternatively, the control unit 200 may set the image writing position for the second sheet based on the average of the image writing positions of the plurality of previously preceding sheets.

Further, in the embodiment described above, after stopping the air blow through the air blow nozzles 116a and 116b, the pickup roller 102 starts feeding the sheet S. However, it is not limited to this, and, for example, it is acceptable that a duty cycle of the fan motors 115a and 115b may include a plurality of stages. For example, the duty cycle can be set to 100% before feeding the sheet, and can be reduced to 50% during feeding the sheet. That is, before starting the feeding of the sheet S by the pickup roller 102, the airflow is blown through the air blow nozzles 116 and 116b at a first air volume (duty cycle 100%). Then, it is acceptable to configure such that the pickup roller 102 starts the feeding of the sheet S after the air blow through the air blow nozzles 116a and 116b has been switched to a second air volume (duty cycle 50%) that is smaller than the first air volume. That is, even if the fan motors 115aand 115b are not stopped, a reduction in the displacement of the sheet side edge position can be expected only by reducing the duty cycle. Thereby, it is possible to adjust the displacement of the sheet side edge position caused by a strong duty cycle at the time of feeding the respective sheet.

Further, in the embodiment described above, the CIS 45 is used as the detection unit for the sheet side edge position. However, it is not limited to this, and, for example, it is acceptable to configure such that, by including a driving motor which moves a sensor for detecting the presence and absence of the sheet S in the sheet width direction W, the sheet side edge position is calculated based on a moving amount of the motor to the sheet side edge position.

Further, in the embodiment described above, the state change operation is the air separation. However, it is not limited to this, and, for example, the state change operation may be an operation of supporting a newly supported sheet S in the sheet cassettes 31b and 32b. That is, in a case where, during the print job, the sheet in the sheet cassettes 31b and 32b becomes depleted and is replenished, it is possible to configure to execute the first processing on the first sheet immediately after the replenishment. This state change operation is an operation of mounting the sheet cassettes 31b and 32b containing a newly accommodated sheet into the casing 1a. Thereby, in a case where the position of the sheet has been changed by the replenishment, it is possible to accurately perform the adjustment of the side edge position of the image. Alternatively, it is acceptable that the state change operation is an operation of supporting a newly placed sheet S on the manual sheet feed tray 101. That is, in a case where, during the print job, the sheet on the manual sheet feed tray 101 becomes depleted and is replenished, it is possible to configure to execute the first processing on the first sheet immediately after the replenishment. This state change operation is an operation of newly supporting the sheet on the manual sheet feed tray 101. Also in this case, in a case where the position of the sheet has been changed by the replenishment, it is possible to accurately perform the adjustment of the side edge position of the image.

Further, the state change operation may be an operation in which the sheet S conveyed by the sheet conveyance unit 40 is switched between the sheet S stored in the sheet cassette 31b and the sheet S stored in the sheet cassette 32b. For example, this is applied to a case where the image formation is performed on a plurality of types of the sheet S during the print job. Thereby, in a case where the sheet cassettes 31b and 32b are switched by the print job, it is possible to accurately perform the adjustment of the side edge position of the image.

Further, while, in the embodiment described above, this disclosure is applied only to the adjustment of the image registration in the image forming unit 2, it is not limited to this. Hitherto, in the image forming apparatuses, a configuration in which, by disposing the CIS 45 at the registration roller 42, based on that detection result, the sheet side edge position is adjusted by displacing the sheet in the width direction W in a state in which the sheet S is being nipped by the registration roller pair 42 is known. By applying the present embodiment in conjunction with the configuration described above, it is possible to displace the sheet S in the sheet width direction W to align with the image writing positions, while sequentially rewriting the image writing positions. That is, the registration roller pair 42 is an example of a conveyance roller pair, and, by nipping and conveying the sheet S and by offsetting in the sheet width direction W, it is possible to adjust the position of the sheet S, which is being nipped, in the sheet width direction W. In the example illustrated in FIG. 5, the registration roller pair 42 offsets the sheet S in the sheet width direction from a first position detected by the CIS 45 and illustrated by a solid line to a second position at which a conveyance center line of the sheet is a conveyance center line C2. During an offset operation, this conveyance center line C2 is positioned at a location (for example, on the front side, i.e., the left side in FIG. 5) different from the feeding center line (center line C1) in the manual sheet feed portion 33. That is, the conveyance center line C2 of the second position is positioned at a position between a conveyance center line of the first position and the center line C1 in the sheet width direction. As a result, it is possible to reduce a shift amount of the sheet S in comparison with a case where this control is not used in combination, and it is possible to suppress the degradation of adjustment accuracy and the enlargement of the apparatus due to a large shift amount of the sheet S.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-105154, filed Jun. 27, 2023 which is hereby incorporated by reference herein in its entirety.

What is claimed is:

1. An image forming apparatus comprising:
a sheet supporting unit configured to support a sheet bundle;
a sheet feeding member configured to feed an uppermost sheet of the sheet bundle supported on the sheet supporting unit by coming into contact with the uppermost sheet;
an image forming unit configured to form an image on a sheet at an image formation position;
a sheet conveyance unit configured to convey the sheet fed by the sheet feeding member to the image formation position;
a detection unit configured to detect a position of the sheet in a sheet width direction intersecting with a sheet conveyance direction of the sheet conveyed by the sheet conveyance unit; and
a control unit configured to control the sheet feeding member, the image forming unit, and the sheet conveyance unit,
wherein the control unit is configured to execute a first processing and a second processing,
wherein, in the first processing, the control unit is configured to control the image forming unit based on a position of the sheet in the sheet width direction obtained by the detection unit such that a position at which the image forming unit forms an image on the sheet of which the detection unit detects the position in the sheet width direction is adjusted in the sheet width direction,
wherein, in the second processing, the control unit is configured to control the image forming unit based on a position of a preceding sheet in the sheet width direction obtained by the detection unit such that a position at which the image forming unit forms an image on a subsequent sheet following the preceding sheet is adjusted in the sheet width direction,
wherein, in a case where a state change operation that changes a feeding state at time of feeding the sheet occurs, the control unit is configured to execute the first processing, and
wherein, in a case where the state change operation does not occur, the control unit is configured to execute the second processing.

2. The image forming apparatus according to claim 1, further comprising:
an air separation unit including a fan configured to blow air, the air separation unit being configured to separate sheets by blowing the air to a side surface of the sheet bundle supported on the sheet supporting unit,
wherein the state change operation includes an operation of separating the sheets by the air separation unit.

3. The image forming apparatus according to claim 2, wherein the control unit is configured to separate the sheets by the air separation unit each time in a case where the sheet feeding member feeds a predetermined number of sheets.

4. The image forming apparatus according to claim 2,
wherein the control unit is configured to blow the air by the air separation unit before the sheet feeding member starts to feed the sheet, and
wherein the control unit is configured to start to feed the sheet after the air separation unit stops blowing the air.

5. The image forming apparatus according to claim 2,
wherein the control unit is configured to blow the air at a first air volume by the air separation unit before the sheet feeding member start to feed the sheet, and
wherein the control unit is configured to start to feed the sheet by the sheet feeding member after an air volume of blowing by the air separation unit is switched to a second air volume that is smaller than the first air volume.

6. The image forming apparatus according to claim 1, wherein the state change operation includes an operation of supporting a newly supported sheet on the sheet supporting unit.

7. The image forming apparatus according to claim 6, wherein the sheet supporting unit includes a manual feed tray configured to support a manually fed sheet.

8. The image forming apparatus according to claim 6, further comprising:
a casing,
wherein the sheet supporting unit includes a sheet accommodating portion configured to accommodate the sheet, the sheet accommodating portion being detachable with respect to the casing, and
wherein the state change operation includes an operation of mounting the sheet accommodating portion into the casing, the sheet accommodating portion accommodating a newly accommodated sheet.

9. The image forming apparatus according to claim 1,
wherein the sheet supporting unit is a first sheet supporting unit,
wherein the sheet feeding member is a first sheet feeding member,
wherein the image forming apparatus further comprises:
a second sheet supporting unit configured to support a sheet bundle; and
a second sheet feeding member configured to feed an uppermost sheet of the sheet bundle supported on the second sheet supporting unit by coming into contact with the uppermost sheet,
wherein the first sheet supporting unit includes a first sheet accommodating portion configured to accommodate the sheet,
wherein the second sheet supporting unit includes a second sheet accommodating portion configured to accommodate the sheet, and
wherein the state change operation includes an operation of switching the sheet conveyed by the sheet conveyance unit between the sheet accommodated in the first sheet accommodating portion and the sheet accommodated in the second sheet accommodating portion.

10. The image forming apparatus according to claim 1, wherein, in the second processing, the control unit is configured to set the position at which the image is formed on the subsequent sheet in the sheet width direction to be a position at which the image has formed on the preceding sheet in the sheet width direction.

11. The image forming apparatus according to claim 1, wherein, in the second processing, the control unit is configured to set the position at which the image is formed on the subsequent sheet in the sheet width direction to be a position obtained based on an average value of positions at which images are formed on a plurality of preceding sheets in the sheet width direction.

12. The image forming apparatus according to claim 11, wherein, in a case where the subsequent sheet is a sheet from a third one onward after occurring the state change operation, until a next state change operation occurs, the control unit is configured to execute the second processing by setting a position at which the image is formed on the subsequent sheet in the sheet width direction to be a position obtained based on an average value of positions at which the images are formed on the plurality of preceding sheets in the sheet width direction.

13. The image forming apparatus according to claim 1, wherein, in the second processing, before the detection unit detects a position in the sheet width direction of the sheet that is conveyed, the control unit is configured to form an image writing signal for forming the image on the sheet by the image forming unit.

14. The image forming apparatus according to claim 1,
wherein the sheet conveyance unit includes a conveyance roller pair,
wherein the conveyance roller pair is configured to convey the sheet by nipping the sheet, and is configured to adjust a position in the sheet width direction of the sheet which is being nipped by offsetting the sheet in the sheet width direction,
wherein the conveyance roller pair is configured to offset the sheet from a first position detected by the detection unit to a second position in the sheet width direction, and
wherein a conveyance center line of the second position is positioned at a position between a conveyance center line of the first position and a feeding center line in the sheet feeding member in the sheet width direction.

15. The image forming apparatus according to claim 1, wherein the control unit is configured to execute the first processing with respect to a single sheet of the sheet.
